(19) United States
(12) Patent Application Publication
(10) Pub. No.: US 2008/0122655 A1
(43) Pub. Date: May 29, 2008

(54) Security System And Method

(75) Inventors: Johan Sedelius Horberg, Halmstad (SE); Dennis Jonsson, Goteborg (SE); Henrik Ehrnlund, Halmstad (SE); Per Mattsson, Halmstad (SE)

Correspondence Address: MERCHANT & GOULD PC, P.O. BOX 2903, MINNEAPOLIS, MN, 55402-0903, US

(73) Assignee: AQUALIV AB, Göteborg (SE)

(21) Appl. No.: 11/629,959

(22) PCT Filed: Jun. 20, 2005
(86) PCT No.: PCT/SE05/00972

§ 371 Date: Dec. 13, 2007

(30) Foreign Application Priority Data
Jun. 18, 2004 (SE) 0401574-9

(51) Int. Cl. G08B 23/00; H04L 12/28

(52) U.S. Cl. 340/984; 340/825.36; 370/338

(57) ABSTRACT

A security system (100) for use on a boat comprising a central unit (1), one or several personal units (2), repeaters (4) and relay boxes (5). Each component includes a radio module. The central unit (1) forms a master and the other components form nodes of a multi-hop network, which 10 wirelessly exchanges information between the components. A method for operating the security system is provided.

### TECHNICAL FIELD

The present invention relates to a security system, which is based on a wireless network, and which in particular is adapted to be used on board of a boat.

The invention also relates to a method for operating the system, wherein a two-way radio technology is provided for transmission of messages and information.

### BACKGROUND OF THE INVENTION

Boating is a popular sport, although there are frequent reports of accidents during the exercise of such boating sports, causing severe damages on both humans and surroundings, such as neighbouring boats, piers or buildings. Some of those accidents happen when the driver of the boat or passengers fall overboard, while the boat continues at maintained speed, powered by the engine, and rapidly travels further and further away from the spot where the person fell into the water.

WO 2004/007276 discloses a security system comprising a boat unit, which is connected to the electrical system of the boat, and a personal unit, which is attached to the driver and may be kept in his pocket, since it is battery powered. The two units communicate with each other by means of radio technology, and are in radio contact when the driver is on board. If the driver falls over board and the radio communication is interrupted, the boat unit automatically stops the engine of the boat.

However, the above-mentioned security system has a drawback, since the system has a limited range of about 50 meters due to the radio range. By increasing the transmission strength the range could be extended, however, this generates another problem regarding larger battery supply. Furthermore, despite an increased range, it is difficult to cover large boats, and when passengers wearing personal units are moving around the boat, several central units and antennas are needed, which require a complicated, expensive and time consuming installation.

The personal units communicate via a certain number of channels within the free frequency band, and when several personal units should be connected to a common central unit, they may interfere with each other. This means that only a limited number of personal units can communicate with a central unit, and this communication cannot be simultaneously performed, but sequentially. In addition, when several boats are in the neighborhood, each having a security system, the radio traffic increases on the frequency band, which may result in interference and failure to communicate. In this case, it may happen that the central unit shuts off the engine despite the fact that the personal unit is still on board. Hence, an accident could easily happen if other boats are around, which do not manage to give way for the non-moving boat.

The security system described above also includes a locking device of the engine, which is based on the fact that only persons wearing personal units with correct identities could lock up and start the engine for preventing theft or sabotage of the boat.

Other current existing immobilizers for boats comprise a box including at least one relay connected with one or several breakpoint(s) such as start power, power trim, and fuel supply. At installation of the immobilizer, the wires to the breakpoints are cut and are then connected in series via the relay(s) of the box. The wires are sometimes not colour coded to make it more difficult to bypass the locking function. The relay(s) is/are often activated and inactivated by a remote control. At activating the immobilizer, every breakpoint of the realy(s) is broken and then the engine cannot start. Those types of immobilizers are easy to find due to the wiring, and despite unmarked wires, an intruder may locate each wire and determine its function by following its length until reaching the original wire of the engine, whereto the wire is connected. The colour of the original wire of the engine tells the intruder how the bypass should be done, and then it is easy to steal the boat. Current immobilizers are difficult and time consuming to install, especially since standards do not exist within the boat industry and different suppliers of boat engines use different electrical circuit.

### SUMMARY OF THE INVENTION

An object of the present invention is to eliminate the drawbacks mentioned above and to provide a reliable security system for the safety of an operator and for passengers on a boat, which is achieved by assigning to the system the characteristics according to claim 1.

In a first aspect, there is provided a security system for use in a boat having propulsion means, such as an engine, the system comprising a central unit mounted on the boat for controlling said propulsion means and having a first radio module and one or several portable personal units having a second radio module, each having an individual identity for communication with the central unit. The central unit is a master and the one or several personal units are nodes in a multi-hop network. The nodes may be arranged in groups, wherein a first group comprises all nodes inside the coverage area of the master, and a second group is outside the coverage area of the master but inside the coverage area of any node of the first group, and a third group is outside the coverage area of the first group but inside the coverage area of the second group.

In an embodiment, the system further comprises one or several repeaters having a third radio module with an individual identity and one or several relay boxes having a fourth radio module with an individual identity, which all form nodes of the multi-hop network. The personal units, the repeaters and the relay boxes may communicate with each other or with the central unit, the communication being a two-way wireless communication. The central unit may intermittently check the presence and the position on the boat of the one or several personal units by transmitting a signal, and if a confirmation signal is not sent back from the one or several personal units to the central unit an alarm is activated. Each of the personal units may comprise an alarm device for sending out an alarm signal, such as a sound signal. The central unit may comprise a control device which intermittently checks the presence of the group of the one or several repeaters and the one or several relay boxes by transmitting a signal, and if no confirmation signal is received an activity may be initiated.

In another embodiment, the system comprises an immobilizer including the one or several relay boxes. The immobilizer may comprise a locking device, which is arranged to be wirelessly locked or unlocked by the central unit, by a relay of the one or several relay boxes or by a predetermined personal unit. The wireless communication may be performed between any of the components selected from the group of the central unit, the one or several personal units, the one or several repeaters or the one or several relay boxes, wherein the communication is performed in one step or in several steps via other components selected from the group.

According to another aspect, there is provided a method for operating the above-mentioned security system.

### BRIEF DESCRIPTION OF THE DRAWINGS

Further objects, features and advantages of the invention will appear from the following detailed description of embodiments with reference to the drawings, in which;

FIG. 1 is a schematic view showing an security system, and

FIG. 2 is a schematic view showing a route within a multi-hop network for transmitting messages and information between a personal unit and a central unit.

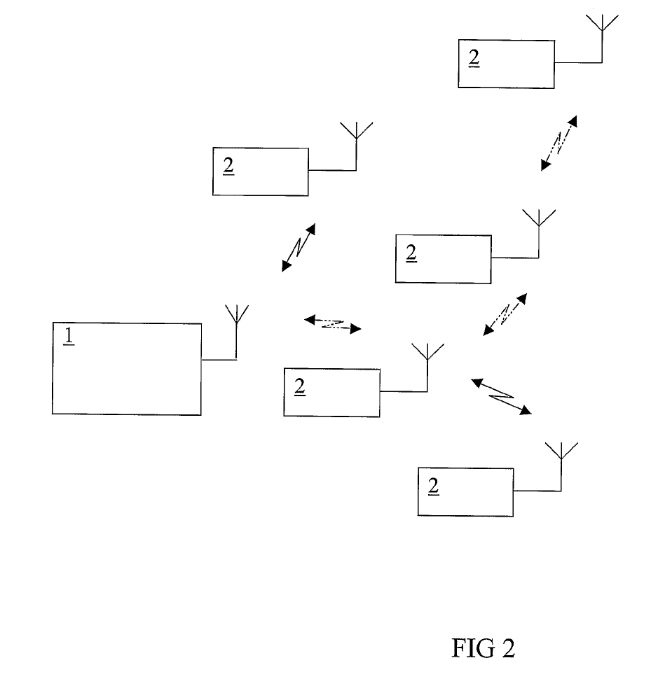

### DESCRIPTION OF EMBODIMENTS OF THE INVENTION

The same reference numerals have been used to indicate the same parts in the figures to increase the readability of the specification and for the sake of clarity.

The wireless security system 100 according to the invention is adapted to be used in a water vehicle, such as a boat or a vessel. The system 100 is based on a wireless multi-hop network including a master and several nodes, wherein the multi-hop radio network is used for messages, information and alarm.

The multi-hop network may be a system as described in the concurrently filed international patent application entitled: “Method and a system for providing communication between several nodes and a master”, the contents of which is included in the present specification by reference.

To summarize, the network comprises a master and several nodes. The nodes are arranged in groups, so that a first group comprises all nodes inside the coverage area of the master. A second group is outside the coverage area of the master but inside the coverage area of any node of the first group, etc. Any node reaches the master via a node in a previous group in a multi-hop approach, and vice versa. The time slots are assigned in dependence of the distance to the master. In a message period, in which the master sends a message to any node, the first group is assigned a first group of time slots, and the second group is assigned a second group of time slots, following the first group of time slots, etc. In this way, the message from the master can be sent out to all nodes in a single message period. When a node wants to send information to the master, the time slots are arranged in the opposite order, in an information period, which means that the information can reach the master in a single information period. Normally, a message period is followed by an information period, which in turn is followed by a sleep period to save battery power.

In the message period, the master broadcasts a message including synchronization information, so that the time slots are well defined. The message may also include further information, so that the nodes comprises information of its own time slot and information of time slots of adjacent nodes. In this way, each node only listens to traffic from the adjacent nodes, and shuts down itself during other time, in order to save battery power.

The node also only transmits in its own time slot and sends information to the master. Such information may include the path the information has passed in the multihop-network, when the information travels from the node, to a next node and finally to the master.

Since the nodes are well synchronized, a long sleep period between transmission times may be used.

If a node moves in the system, its position between the groups may change. This is taken care of by the master, which notes which path or route the information travels. In the next message sent by the master, the new situation is transmitted to the nodes.

If a node does not respond during its time slot, the node is considered to be lost, and an alarm is given to the system, as described below.

The master may try to contact the node once again at no response before issuing an alarm, since the failure to respond may be due to a temporary condition of bad transmission. If the second attempt is without success, an alarm is issued.

If the node falls into the water, the radio transmission from the node is decreased or dampened. Moreover, if water enters the electronics inside the node, the radio will also stop to operate.

The system may comprise several more or less fixed nodes, acting as repeaters, so that the nodes can communicate with the master wherever the nodes are on a restricted area, such as a boat. The moveable nodes themselves also act as repeaters. Such fixed repeaters can be connected to a wired power supply, i.e. they are not dependent on battery power. Such repeaters may act as masters in the above-mentioned multi-hop system, and may communicate directly with the central unit 1 to initiate an alarm. Alternatively, such a repeater may act as a node, although it is immobile.

In some cases, it is required to wake up all the nodes during a sleep period, for example in an emergency case. This may take place by the master emitting a Dirac pulse. A Dirac pulse is a pulse having infinite short time duration and a unity of energy. Such a pulse consists of all frequencies and can be heard by any receiver. In this case, all nodes need to have a receiver active during the sleep period, or at least during part of the sleep period. At least the master may be provided with a Dirac pulse generator, since the master normally is connected to the mains supply. Some of the nodes can also emit Dirac pulses, which however consumes battery power.

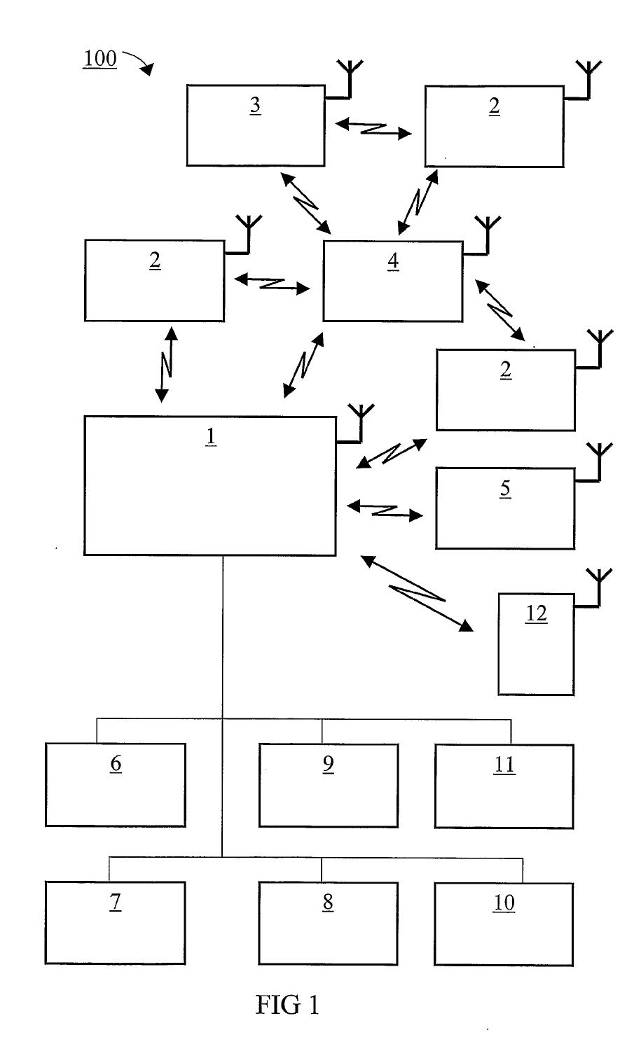

With reference to FIG. 1, the system 100 comprises a central unit 1, one or several personal units 2, one or several external sensors 3, one or several repeater(s) 4, and one or several relay box(es) 5. The connection unit 1 is the master of the multi-hop network and the components 2, 3, 4, 5 are nodes of the network, which all include a multi-hop radio module. The central unit 1 and the personal units 2 can communicate wireless with each other and with other components 3, 4, 5 of the system 100 as being a part of the multi-hop network.

The central unit 1 further comprises for example a Bluetooth module, GPS (Global Positioning System), internal relays, one or several sensors, an RFID (Radio Frequency Identity)-reader and means for navigation and operation of the boat. The central unit 1 can communicate wireless with or be connected to a data bus 6, a motor control 7, a display 8, an external GPS 9, a sound or light alarm 10, a communication/satellite-radio 11, and a mobile telephone 12.

The central unit 1 controls the entire system 100. At emergency, an alarm is sent from the central unit 1 via GSM/GPRS/3G, or other mobile telephone standard 12, or external communication/satellite radio 11 to a monitoring centre. The central unit 1 can stop the engine of the boat or perform other preset activities if a man over board is detected, and can affect the propulsion means or control means of the boat by the data bus 6 or by closing or opening the circuits of the operation means of the boat. In addition, the sensors 3 of the central unit 1 can detect grounding. By the external GPS 9 it is possible to register time and position for an emergency situation, which information together with the name of the boat and the passengers can be sent by the communication radio 11 or by the mobile telephone 12 to the external monitoring centre. The Bluetooth module of the central unit 1 enables communication with the mobile telephone 12 having Bluetooth, which may also be used as a personal unit 2, and hence be monitored by the central unit 1, or which can be used as a display or a control means for setting the different functions of the central unit 1.

Individuals, i.e. passengers and staff, on board the boat, wear the personal units 2. The system 100 detects when contact with a personal unit 2 is lost, e.g. when there is not communication over the multi-hop radio network. This is the case if the radio module of a lost personal unit 2 either is in the water, the radio waves being stopped, or has been moved outside the radio range, anyhow, the system signals man over board. All personal units 2 have knowledge of its own position and the position of its neighbours in the network and then also know to which neighbour a message should be sent, e.g. in an emergency situation. At emergency all the non-involved personal units 2 can alarm, i.e. a signal will be heard.

When the central unit 1 comprises an RFID-reader, the personal units 2 comprise an RFID-transponder. The RFID-reader detects the transponders when those are located within the range of the RFID-reader. Thus, the RFID-technology can be used for input of the personal units 2, which should be a part of the system 100. The RFID-transponders can also be used as keys for locking up the immobilizer, either as a primary key or as a spare key.

There are several classes of personal units 2, wherein some only generate an alarm on the central unit 1, while others generate a total stop of the engine and the operation of the boat. The classification is dynamic, and depends on the role of the individual wearing the personal unit 2 when being on the boat. The personal units 2 have each a specific identity that is recognized by the system 1. For example, if the driver of the boat falls into the water, the result will be a total stop of the engine, but if a passenger falls over board, probably an alarm will be seen on a display of the central unit 1 together with a sound signal from the external sound alarm 10 and from the personal units 2 which are not in emergency.

An immobilizer of the system 100 involves the one or several relay box(es) 5, and the one or several relay(s) of the central unit 1. The radio module (multi-hop) of the relay box 5 controls the realy(s) inside the box that is connected to a wire to the engine of the boat. When the relay is either closed or opened in relation to the construction of the engine of the boat, it is impossible to start the boat. To get access or lock up the system 100, i.e. lock up the immobilizer, via the multi-hop radio it is necessary to have a correct identity of the personal unit 2, which is preset via the central unit 1. Locking up the system 100 can be performed either directly by the multi-hop network via the identity of the personal unit 2 or via a mobile telephone 12, which can be used as a personal unit 2, or via the central unit 1. The central unit 1 communicates wirelessly with the relay boxes 5, which makes it easier to arrange them invisible making it more difficult for intruders or thieves to find them. An immobilizer that is more difficult to lock up can be obtained if several break points are arranged, wherein each is connected to a realy box 5 having a radio module. Depending on the number of relay boxes 5 that are installed, the number of break points is optional, which gives a flexible, customer adapted immobilizer.

From the central unit 1 it is also possible to lock/lock up the engine, since there is a connection to the motor control 7, which could be used in situations when the immobilizer described above is not required.

A specific network having continuous power supply units, so called repeaters 4, can be installed to be used at severe conditions, e.g. bad weather, or when the boat is large and a larger area has to be covered within the network. The repeaters 4 have two main advantages: faster response time, when several personal units 2 are used, and increased freedom to move around at large boats. The physical location of a repeater 4 is carefully chosen, so that some of the personal units 2 can reach this repeater 4 by a single hop, and the repeater 4 will then transmit the messages to a neighbouring personal unit 2 or to the central unit 1. Using repeaters 4 result in decreased reaction time for the system 100. As mentioned above, the repeaters may be a node in the system 100 or may each act as a master in the multihop network.

An external display 8 can be connected to the central unit 1 for displaying the personal units 2 and/or sensors that are in operation, and e.g. their battery status and position. The display 8 can also show position, bearing, time and numbers of individuals on board at an emergency situation.

External light- and sound alarms 10 can be connected with the central unit 1, which will activate them at emergency.

There are several advantages of the security system 100 according to the invention compared to currently used security systems. The multi-hop radio technology forms a dynamic network, which makes it easy to add more sensors, personal units 2, or other components having a radio module to the system 100, and to move between different areas within the system 100.

The multi-hop radio network is a reliable system 100, wherein the central unit 1 periodically wakes up the entire system 100 checking that all sensors and personal units 2 still are present and that no personal unit 2 has disappeared or is not working. Simultaneously, the sensors and the personal units 2 are able to regularly send information, e.g. regarding battery status, to the central unit 1 when the system 100 wakes up, contrary to currently used systems which only offer information to be sent in one direction.

The multi-hop network has a larger radio range and can cover larger areas than the systems of today because of the multihop technology. The personal units 2 of the security system 100, each having a multi-hop radio module, know their closest neighbours and can communicate further to the master.

The system 100 offers also due to the multi-hop radio technology an immobilizer that makes it difficult to lock up the engine of the boat or to give access to operation and control functions for intruders.

Although the present invention has been described above with reference to specific embodiments, it is not intended to be limited to the specific form set forth herein. Rather, the invention is limited only by the accompanying claims, and other embodiments than those specifically described above are equally possible within the scope of these appended claims.

In the claims, the term “comprises/comprising” does not exclude the presence of other elements or steps. Furthermore, although individually listed, a plurality of means, elements or method steps may be implemented. Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way.

1. A security system for use in a boat having propulsion means, such as an engine, the system comprising a central unit mounted on the boat for controlling said propulsion means and having a first radio module and one or several portable personal units having a second radio module, each having an individual identity for communication with the central unit wherein the central unit is a master and the one or several personal units are nodes in a multi-hop network.

2. The security system according to claim 1, wherein the nodes are arranged in groups, wherein a first group comprises all nodes inside the coverage area of the master, and a second group is outside the coverage area of the master but inside the coverage area of any node of the first group, and a third group is outside the coverage area of the first group but inside the coverage area of the second group.

3. The security system according to claim 1 wherein the system further comprises one or several repeaters having a third radio module with an individual identity and one or several relay boxes having a fourth radio module with an individual identity, which all form nodes of the multi-hop network.

4. The security system according to claim 1, wherein the one or several personal units, the one or several repeaters and the one or several relay boxes communicate with each other or with the central unit, the communication being a two-way wireless communication.

5. The security system according to claim 1, wherein the central unit intermittently checks the presence and the position on the boat of the one or several personal units by transmitting a signal, and if a confirmation signal is not sent back from the one or several personal units to the central unit an alarm is activated.

6. The security system according to claim 5, wherein each of the personal units comprises an alarm device for sending out an alarm signal, such as a sound signal.

7. The security system according to claim 1, wherein the central unit comprises a control device which intermittently checks the presence of the group of the one or several repeaters and the one or several relay boxes by transmitting a signal, and if no confirmation signal is received an activity is initiated.

8. The security system according to claim 1, wherein the system comprises an immobilizer including the one or several relay boxes.

9. The security system according to claim 8, wherein the immobilizer comprises a locking device, which is arranged to be wirelessly locked or unlocked by the central unit, by a relay of the one or several relay boxes or by a predetermined personal unit.

10. The security system according to claim 1, wherein the wireless communication is performed between any of the components selected from the group of the central unit, the one or several personal units, the one or several repeaters or the one or several relay boxes, wherein the communication is performed in one step or in several steps via other components selected from the group.

11. A method of operating a security system for use in a boat having propulsion means, such as an engine, the system comprising a central unit mounted on the boat for controlling said propulsion means and having a first radio module and one or several portable personal units having a second radio module, each having an individual identity for communication with the central unit, the method comprising sending a message from the first radio module of said central unit acting as master in a multihop network, and receiving answers from the second radio modules of each personal unit acting as nodes in said multihop network, either directly or via another node.

12. The method according to claim 11, wherein the nodes are arranged in groups, wherein a first group comprises all nodes inside the coverage area of the master, and a second group is outside the coverage area of the master but inside the coverage area of any node of the first group, and a third group is outside the coverage area of the first group but inside the coverage area of the second group.

13. The method according to claim 11 wherein the system further comprises one or several repeaters having a third radio module with an individual identity and one or several relay boxes having a fourth radio module with an individual identity, which all form nodes of the multi-hop network.

14. The method according to claim 11, wherein two-way wireless communication between the central unit and at least on of the one or several personal units, the one or several repeaters and the one or several relay boxes.

15. The method claim 11, further comprising intermittently checking by the central unit the presence and the position on the boat of the one or several personal units by transmitting a signal, and activating an alarm if a confirmation signal is not sent back from the one or several personal units to the central unit.

16. The method according to claim 15, wherein activating the alarm comprises sending an alarm signal by each of the personal units, such as a sound signal.

17. The method according to claim 11, further comprising intermittently checking by the central unit the presence of the group of the one or several repeaters and the one or several relay boxes by transmitting a signal, and initiating an activity if no confirmation signal is received.

18. The method according to claim 11, wherein the system comprises an immobilizer including the one or several relay boxes.

19. The method according to claim 18, further comprising wirelessly locking or unlocking the immobilizer by the central unit, by a relay of the one or several relay boxes or by a predetermined personal unit.

20. The method according to claim 11, wherein the wireless communication is performed between any of the components selected from the group of the central unit, the one or several personal units, the one or several repeaters or the one or several relay boxes, wherein the communication is performed in one step or in several steps via other components selected from the group.
